(19) United States
(12) Patent Application Publication
(10) Pub. No.: US 2003/0230934 A1
(43) Pub. Date: Dec. 18, 2003

(54) Modular power supply with multiple and interchangeable output units for AC- and DC-powered equipment

(76) Inventors: Gary Gerard Cordelli, Indialantic, FL (US); Henry Michael Wolff, Bethesda, MD (US)

Correspondence Address: Gary G. Cordelli, 404 Rio Villa Boulevard, Indialantic, FL, 32903, US

(21) Appl. No.: 10/173,248

(22) Filed: Jun. 17, 2002

(51) Int. Cl. H02J 1/00

(52) U.S. Cl. 307/43

(57) ABSTRACT

The modular power supply of the present invention provides a new device and method for powering multiple portable and/or small devices each requiring an AC or DC current source at one of various low-voltage levels. The invention comprises a main power base that is capable of converting AC power levels in common use internationally into a main low-level DC bus, which may, for example, be 24VDC. The AC input source and the derived DC voltage are then supplied via separate buses to smaller power “blocks” of two distinct designs, one for transforming the AC bus voltage to a low-voltage AC output, and one for converting the DC bus voltage to a low-voltage DC output. The DC blocks are of a common design, but are differentiated in that their respective output voltages are set by a “programming” element. The AC blocks are of a second common design, but are differentiated in that their respective output voltages are set by a “programming” transformer. All of these power “blocks” are of such a physical design that any DC block can only make contact with the DC bus and any AC block can only make contact with the AC bus. All of the blocks share a common output connector type and a common shape. In this way, a certain number of blocks, set by the size and output power of the power base unit, may be chosen from the group of all AC and DC blocks. Such blocks can be interchanged in placement on the power base unit in various permutations so as to meet the AC or DC input requirements of the various equipment that is to be powered by the invention.

### SPECIFICATION

| | |
|---|---|
| Title: | Modular Power Supply with Multiple and |
| | Interchangeable Output Units for |
| | AC- and DC- Powered Equipment |
| Inventors: | Gary Cordelli, Indialantic, FL |
| | Henry Michael Wolff, Bethesda, MD |
| Assignees: | Gary Cordelli, Indialantic, FL |
| | Henry Michael Wolff, Bethesda, MD |
| Correspondence: | Gary Cordelli |
| | 404 Rio Villa Boulevard |
| | Indialantic, FL 32903 |
| | [Email: gary@cordelli.net] |

### REFERENCES

### U.S. Patent Documents

| | | | |
|---|---|---|---|
| 4,538,073 | Aug. 27, 1985 | Freige, et al | 307/33 |
| 4,638,178 | Jan. 20, 1987 | Kayser | 307/85 |
| 4,814,963 | Mar. 21, 1989 | Peterson | 363/20 |
| 5,289,363 | Feb. 22, 1994 | Ferchau, et al | 363/141 |
| 5,510,691 | May 23, 1996 | Palatov | 320/2 |
| 5,576,941 | Nov. 19, 1996 | Nguyen,et al | 363/21 |
| 5,880,932 | Mar. 9, 1999 | Jelinger | 361/695 |
| 5,969,938 | Oct. 19, 1999 | Byrne, et al | 361/678 |
| 5,993,241 | Nov. 30, 1999 | Olsen, et al | 439/378 |
| 6,002,596 | Dec. 14, 1999 | Meyer, et al | 363/21 |
| 6,046,921 | Apr. 4, 2000 | Tracewell, et al. | 363/141 |

### FIELD OF THE INVENTION

The present invention relates to the field of power supplies for low-voltage electronic devices and portable computers and computer peripherals. In particular, this invention relates to a system for the efficient generation of multiple and various low-level AC and DC voltages, from commonly available AC and/or DC power sources. More specifically, the invention directs itself to a system which allows user's of multiple electronic computing and communications devices to power these devices with a single, small, lightweight supply, customized for the power requirements of their particular set of devices.

### BACKGROUND OF THE INVENTION

Electronic appliances, devices, computers and computer peripherals are becoming smaller and more portable every day. Many of these types of equipment are powered by internal batteries, either replaceable or not, with an external power supply providing recharging current to said batteries. Others are powered exclusively by an external power supply providing a direct battery replacement via a DC voltage source, which may or may not be internally converted to one or more different DC voltage levels, for use by the various internal electronic circuits and/or modules. Still others are powered by an external power supply providing, via a simple transformer circuit, a low-level AC voltage source, which is internally rectified and filtered by the equipment to create the required DC voltage or voltages for device operation.

In the above three cases, the external power supply is generally of a type commonly known as a “wall wart” because of its shape. These supplies are generally heavy, bulky blocks with a male plug for connecting to the AC outlet and a long cord terminated by a female plug for connecting to the equipment to be powered. The “wall wart” term was adopted as a descriptive one, relating to the look of such supplies when plugged into AC wall outlets. Since these “wall warts” are larger than a normal AC plug and use polarized plug styles (for safety), and sometimes even three-prong, grounded plug styles in North American markets, only one such supply can be plugged into a standard vertically-arranged AC dual wall outlet.

As the number of electronic devices has multiplied, the use of“outlet strips” has grown. These outlet strips provide multiple outlets, generally arranged horizontally, on a long narrow box which itself can be plugged into a single AC wall outlet using a normal plug. In some cases, these “outlet strips” also provide for some surge protection from transients on the AC line. Because the outlets in these strips are generally not separated from each other by more than the space required for a standard AC plug, it is generally the case that a “wall wart” supply will at least partially cover the adjacent outlets when it is plugged into such a strip. This can mean that one or two outlets are “wasted” for each outlet with a “wall wart” supply plugged into it. Even with judicious placement of such “wall warts”, it may be possible to utilize only three outlets on a common six-outlet strip.

With the advent of high-power laptop computers and other portable computing equipment, a second type of external supply has also become popular. Because of the size and weight of the components required for higher-wattage power transfer, this second type is simply too heavy and/or large to plug into a wall outlet. The weight of the supply itself would tend to pull it out of the wall outlet. Such “table top” supplies, sometimes called “bricks”, generally have a cord with a female plug for connecting to the equipment to be powered, just as is the case for “wall wart” supplies. However, this second type of supply generally uses a captive or separate AC line cord for connecting to the AC outlet. In this case, such a supply could be used with either a wall outlet or an outlet strip without blocking adjacent outlets. Unfortunately, such supplies have DC outputs designed to power only the particular computer or electronic device for which they were manufactured, so users of multiple electronic equipment are generally faced with using multiple “wall wart” supplies even when they also have equipment using a “table top” supply.

A further complication is that each “wall wart” or “table top” supply is designed to provide the precise AC or DC input voltages required by the equipment for which they were manufactured. As such, it is difficult, if not impossible to find replacement supplies from other than the original manufacturer. There are simply too many different devices each with different voltage requirements. And since the output power of a supply directly relates to the size of the supply, manufacturers are reluctant to reduce the number of different supplies by designing just one for each different voltage. They manufacture different supplies for different AC/DC current requirements, so that a particular device's supply will not have to be any larger than necessary.

All of this means that there is a different “wall wart” or “table top” supply required for every different device, and a user of several devices must necessarily have to contend with several different supplies. The total bulk and weight of these supplies often makes the “portable” equipment that tends most to utilize such supplies decidedly non-portable.

A common scenario with “stationary” equipment might be a small business with a cordless telephone base, a telephone answering machine, and a LAN “hub” allowing printer and/or file sharing for several desktop computers. Each of these devices has its own separate “wall wart” power supply. In this situation, even two nearby dual-outlet AC wall outlets will not suffice, and so a multiple-outlet “strip” must be used to plug in these three “wall warts”.

Another common scenario, this time with “portable” equipment, is a “portable office” user with a “laptop” computer, a portable “ink jet” printer, an external disk drive, a modem and a camera for video conferencing with the home office. Currently, the modem may be a device internal to the laptop computer, but each of the other four devices might have its own external power supply. Based on the above devices, it is likely that the user will have to contend with a “table top” supply for the computer and three different “wall wart” supplies for the other external devices. To be sure that enough wall outlets are available for these four power supplies, the user may also require a multiple-outlet “strip”. When this user packs up their equipment for transport, they might discover that the additional bulk and weight of the outlet strip and four power supplies exceeds that of the printer, disk drive and camera, combined!

A different situation exists when the “portable office” user is truly “on the road.” In this case, the user may not have access to an AC outlet at all. Since a commonly available power source in this situation might be the “cigarette lighter” style outlet from the car's battery, it would be nice if all the above equipment could just run off of the 12VDC supplied by this automobile outlet. Unfortunately, this is never the case. If this user was lucky enough to have even one of their devices specify an input voltage requirement of “+12V DC”, it is unlikely that the automobile battery would actually supply the necessary level. A “+12V DC” automobile battery may actually supply DC voltage across a wide range, perhaps from +9V to +14V DC.

At one end of this range, the user's “12VDC” equipment might not work at all, while at the other, it might suffer physical damage! At various levels in between, the device may “power up”, but work intermittently or incorrectly.

The designs of the “table top” and “wall wart” supplies tend to be very similar, the difference generally being the level of power available from these two different common styles of “battery replacement” supplies. What is similar about most of these supplies is that they comprise an AC/DC transformation circuit followed by a DC/DC conversion circuit. The AC/DC circuit generally consists of an AC power transformer, a rectifier for changing the AC into DC and a large “filter” capacitor to smooth the output into a relatively “flat” DC level. The DC/DC conversion circuit may consist of a “linear” regulator and additional “filter” capacitor for converting the DC voltage from the AC/DC circuit down to the desired DC output level and further smoothing out the “ripple” in the signal. Because this “linear” supply design creates a lower DC output level from the higher DC level coming from the AC/DC circuit by dissipating the excess power as heat, its efficiency is generally fairly low, and so is limited in use today to only low-power “wall wart” supplies.

The higher power “wall wart” and “table top” supplies generally use a newer “switching” type power supply. The “switching” supply also rectifies the AC voltage and then stores this energy in a “hold-up” capacitor to create a DC voltage source. It then utilizes one of several different types of Pulse-Width Modulated (PWM) circuits to switch this energy into and out of the DC/DC converter circuit to store energy in an output capacitor at a specified voltage level. This voltage level may be above or below the rectified voltage level, depending on the type of PWM and AC/DC circuit used. Because power is not intentionally being dissipated as heat, these “switching” supplies can have a much higher efficiency, perhaps in the 90% range today.

An exception to the above design types is the AC-output type of “wall wart” supply, which generally contains only an AC power transformer and some filtering circuitry to provide a low-level AC voltage from an AC mains source. This type of supply requires the rectification and filtering circuitry to reside within the device itself, and is becoming less common today as equipment manufacturers seek to reduce the size of the devices themselves.

Each of the above supplies shares a common element, the AC power transformer, which represents the largest and heaviest single component in all of the designs. The DC-output supplies, which are far more common than the AC-output supplies, also share the rectification circuits. The linear or switching DC/DC converter is the circuit that differentiates each of the supplies. As a result, many of the components of a “battery replacement” supply are duplicated when users find themselves in need of several such supplies, as described in the earlier examples.

What is needed, therefore, is a common AC/DC transformation circuit with enough power output to supply several different DC/DC converter circuits via a common DC voltage bus. This will eliminate the redundant circuitry in having several AC/DC circuits. It will further take advantage of the fact that a single AC power transformer, rectifier and “filter” capacitor sized for the combined power requirements of several devices will tend to be smaller than the multiplicity of such individually smaller components sized for the individually smaller power requirements of each device. In addition, this single AC/DC circuit can be powered via a single AC power plug and provide its own surge protection so that no outlet strip is required.

What is also needed is a common DC/DC converter circuit, easily “programmed” by a single component to supply a specific output voltage from the above common DC bus. This will also take advantage of “economies of scale” in that a single design will allow the DC/DC converter to be manufactured as a standard part, rather than requiring the custom converters now used in every different supply.

What is further needed is a mechanism by which the latter common DC/DC converter circuits may be plugged into the former AC/DC transformation circuit's common DC voltage bus so that an individual user might customize their combined supply to provide the specific voltage outputs required by their own particular set of equipment.

What is also needed is a DC/DC converter option to convert the nominal 12VDC (or other minimally regulated portable battery voltage) available in automotive or other DC power source into the voltage otherwise supplied by AC/DC circuit's common DC voltage bus, and which can further supply this common DC voltage to the bus in place of the AC/DC circuit.

Lastly, what is needed is a portable option that would comprise only the common DC bus mechanism so that the above DC/DC converter could be used without the AC/DC circuit for circumstances where the AC input capability is not needed.

### BRIEF SUMMARY OF THE INVENTION

The modular power supply of the present invention comprises both an apparatus and a method of providing users with a multiplicity of power sources with various output voltages, customizable for the specific requirements of the particular set of equipment being powered, all derived from a commonly available power source.

First, the present invention uses standardized power converters implemented in small modules which can be “programmed” for a specific output voltage through the use of a single circuit element. In the case of the less used AC-output modules, this element will likely be installed during module manufacturing. In the case of the much more common DC-output modules, this element will be installed into a common manufactured module in a post-manufacturing phase to allow setting of the particular output voltage to occur “just-in-time” for shipment to resellers or end-users. Each of the output modules makes use of a common male power connector and a common output cord that has one captive common female power connector for mating with the module and one universal end connector that uses one of several terminal connectors. The connector inserted into this universal end connector is chosen to mate with the connector on the equipment being powered.

Second, the present invention uses a common DC power bus to drive all DC-output modules and a common AC power bus to drive all AC-output modules. These common buses are derived from a single AC/DC base unit that can be connected to a standard AC outlet via a standard IEC (International Electrotechnical Commission) male power connector using any of the set of commonly available IEC-female to International-male plug AC power cords.

Third, the present invention provides for internal surge and transient protection on the AC input, as well as EMI filtering to meet international standards. It also provides for international AC voltage handling with power-factor correction so that users may travel from place to place without requiring a change in their power supply configuration other than the selection of the proper international cord-set to match the outlet available.

Fourth, the present invention provides optional “protection” modules, physically interchangeable with the AC and DC power output modules, but which provide for surge and transient protection for such things as telephone, network and other data-link cabling as the user may from time to time utilize in their particular equipment setup.

Fifth, the present invention provides an optional DC/DC converter input module that can provide an alternate DC source for the common DC bus in place of the AC/DC transformation circuit. This input module can be used to power all of the DC-output modules from a commonly available DC source such as an automobile battery even though that source may vary widely in the voltage supplied.

Finally, the present invention provides an optional DC-only configuration that utilizes the DC/DC input module and a DC bus module. These two modules comprise a DC base unit, which in place of the AC/DC base unit can be used to power a multiplicity of modules from the set of any of the DC-output or “protection” modules.

### BRIEF DESCRIPTION OF THE SEVERAL VIEWS OF THE DRAWINGS

FIG. 1a is a schematic view showing a set of devices being powered by commonly available “wall wart” and “table top” external power supplies, and FIG. 1b is a view of the same set of devices being powered by the present invention in one expected embodiment thereof;

FIG. 2 is a schematic view showing one of the common DC-output blocks and its connection, via a universal output cord, to a device being powered;

FIG. 3 is a schematic view showing one of the common AC-output blocks and its connection, via a universal output cord, to a device being powered;

FIG. 4 is a schematic view showing one of the “protection” blocks and its connection to the device being protected;

FIG. 5 is a schematic view showing the AC/DC base unit and its connection, via the standard IEC AC inlet, to common AC outlets using one of a set of commonly available international power cords;

FIG. 6 is a block diagram showing the components of the AC/DC base unit that provide for the generation of the common AC, DC and Ground buses;

FIG. 7 is a schematic view of the AC/DC base unit with partial exterior cut-away showing how the method of driving the common AC, DC and Ground buses;

FIG. 8 is a schematic view showing how a DC-output block is connected to the AC/DC base unit DC output and ground bus;

FIG. 9 is a schematic view showing how an AC-output block is connected to the AC/DC base unit AC bus;

FIG. 10 is a schematic view showing how an exemplary “protection” block is connected to the AC/DC base unit DC ground bus;

FIG. 11 is a schematic view showing the optional 12V (or 48V) DC/DC converter input module, through its connection to the AC/DC base unit, supplying the common DC bus power for the DC-output and “protection” blocks;

### DETAILED DESCRIPTION OF THE INVENTION

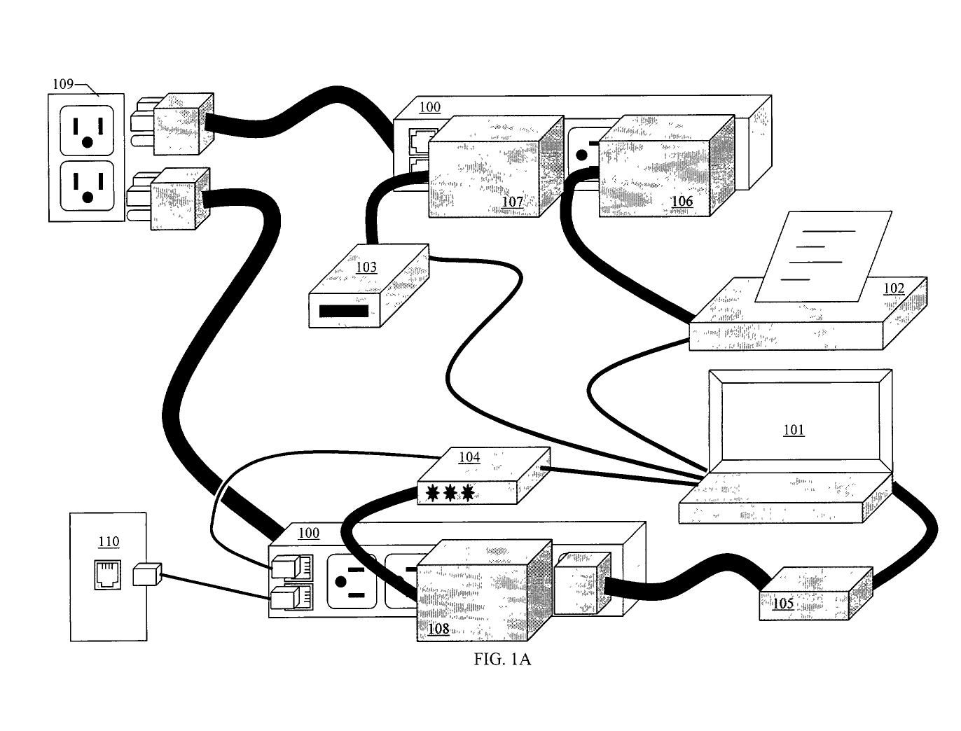

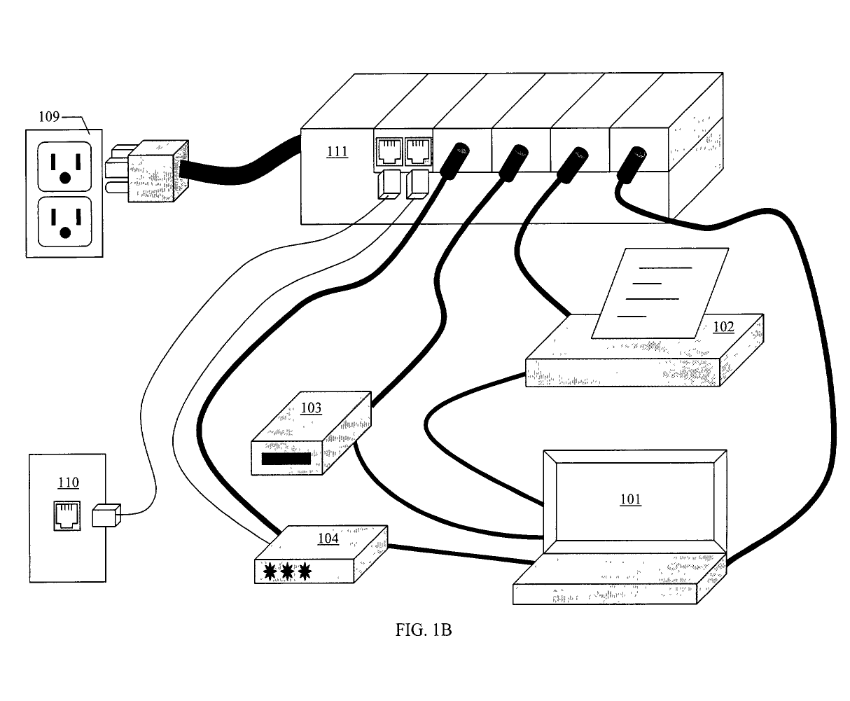

Referring first to FIG. 1a, four devices, a laptop computer, portable printer, storage drive and modem (101-104, respectively) are connected via external power supplies (105-108) of the “wall wart” or “table-top” style to an available mains AC outlet (109) using common AC outlet strips (100). These strips are of the variety containing built-in telephone line filters, and the modem (104) is connected to the public-switched telephone network (PSTN) outlet (110) through this filter. Alternatively, in FIG. 1b, the same four devices (101-104) are connected to a likewise available mains AC outlet (109) using the present invention (111), each via a DC-output block and a “universal” DC power cord terminated with the proper plug to mate with the respective device. The modem (104) is again connected to the PSTN outlet (110), this time through a “protection” block of present invention. The configuration of the present invention and the “universal” DC power cords are described in subsequent figures.

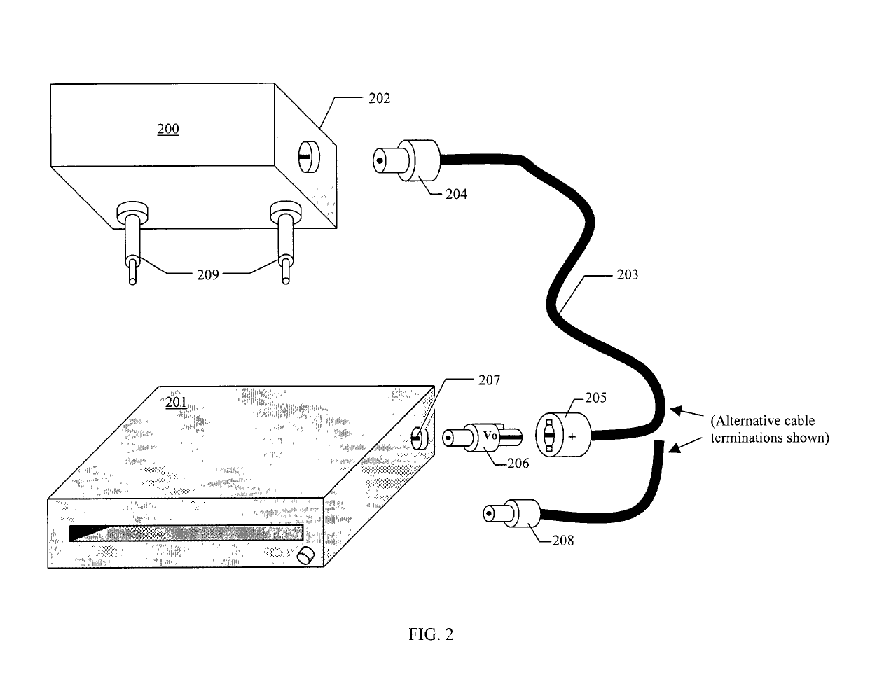

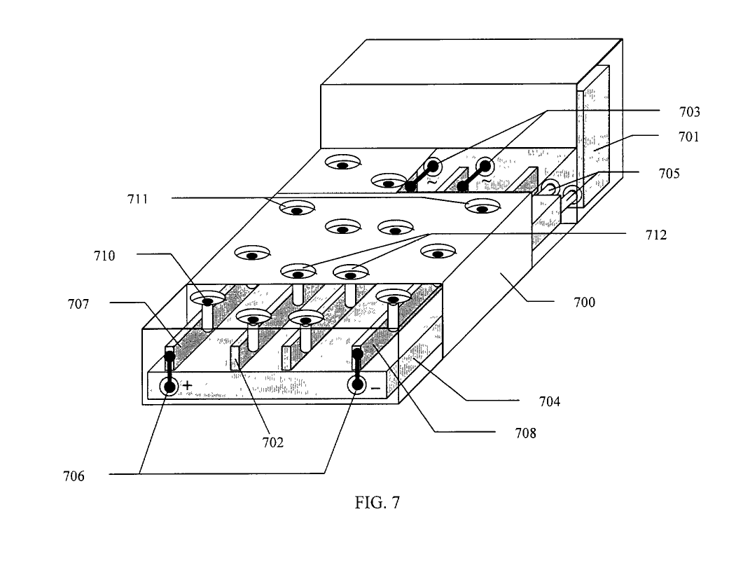

In FIG. 2, the connection between one of the DC-output blocks (200) and a device being powered (201) is shown in more detail. The block directs its output to a power jack (202), which is of a common type and size for all DC-output blocks, regardless of output voltage. A “universal” low-voltage DC power cord (203) is equipped with a one permanent plug (204) to mate with this common jack. The opposite end of this cord is terminated by a universal socket (205) that accepts one of a multitude of male or female power plugs (206), chosen to match the DC power input jack (207) on the device being powered. A “key” on the power plugs mates with one of two “key” slots in the universal socket such that either a positive or negative polarity may be selected by proper orientation of the plug before insertion. Alternatively, the low-voltage power cords may be made in several varieties, each with one plug (204) designed to mate with the common jack at one end and one of a multitude of male or female power plugs (208) at the other end. The two widely spaced pins (209) are used to connect the DC-output block to the AC/DC base unit (see FIG. 7).

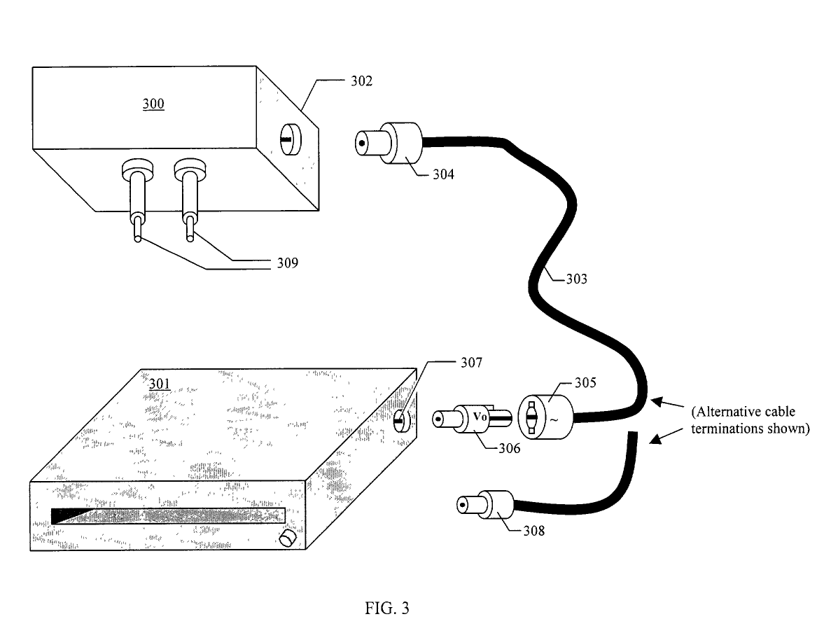

In FIG. 3, the connection between one of the AC-output blocks (300) and a device being powered (301) is shown in more detail. The block directs its output to a power jack (302), which is of a common type and size for all AC-output blocks, regardless of output voltage. A “universal” low-voltage AC power cord (303) is equipped with a one permanent plug (304) to mate with this common jack. The opposite end of this cord is terminated by a universal socket (305) that accepts one of many male or female power plugs (306), chosen to match the AC power input jack (307) on the device being powered. A “key” on the power plugs mates with one of two “key” slots in the universal socket. Since the AC-output blocks supply a non-polarized voltage, the two possible orientations of the plug produce the same output. Alternatively, the low-voltage power cords may be made in several varieties, each with one plug (304) designed to mate with the common jack at one end and one of a multitude of male or female power plugs (308) at the other end. The two closely spaced pins (309) are used to connect the AC-output block to the AC/DC base unit (see FIG. 7).

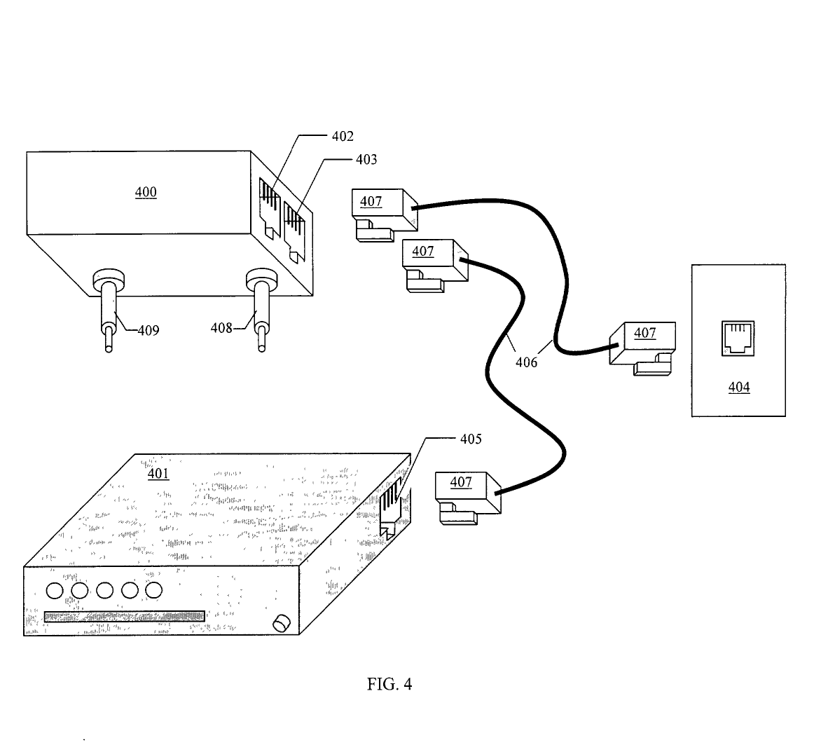

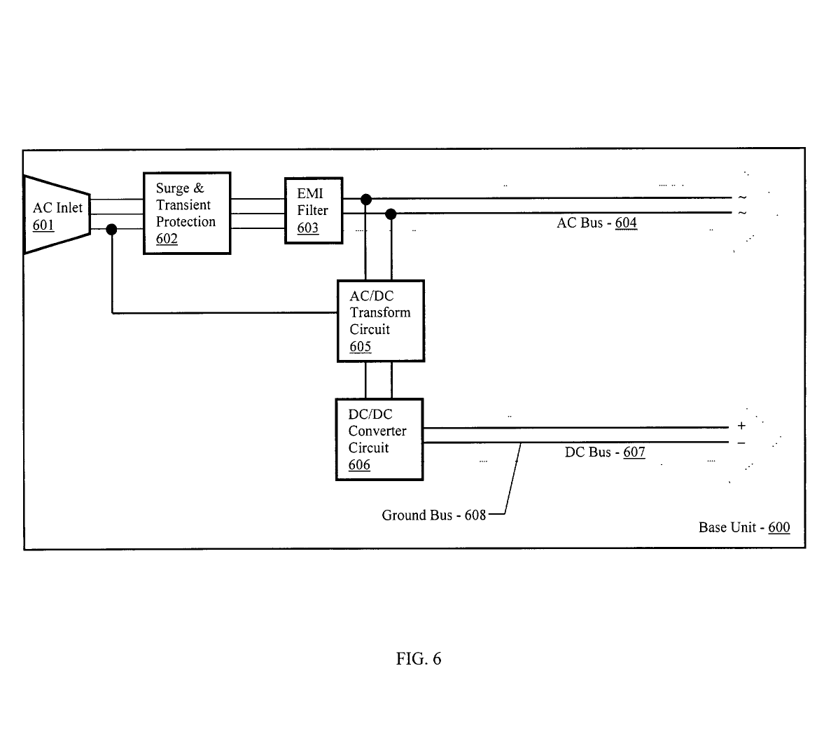

In FIG. 4, the connection between one of the “protection” blocks (400) and the device being protected (401) is shown in more detail. In this example, the device being protected is a modem, and the protected interface is the phone line entering the modem from the Public Switched Telephone Network (PSTN). The protection block is interposed electrically between the PSTN and the modem via a pair of standard RJ-11 jacks (402, 403). The PSTN outlet (404) is connected to the “line in” jack (402) on the protection block, while the modem line jack (405) is connected to the “line out” jack (403), both via standard telephone cables (406) terminated by standard RJ-11 plugs (407). Each of the four conductors is protected via a standard telecom fuse placed in-line between the same pins on the “line-in” and “line out” jacks. In addition, a varistor is placed between each pin on the “line-in” jack and the common ground bus to which the protection block is connected (see FIG. 6). Similar configurations may be used to protect LAN or other data interface connections. Each variety of “protection” block is connected to the AC/DC base unit via two widely-spaced pins, one (408) electrically connecting the block to the DC ground while the other (409) is present for mechanical connection only (see FIG. 7).

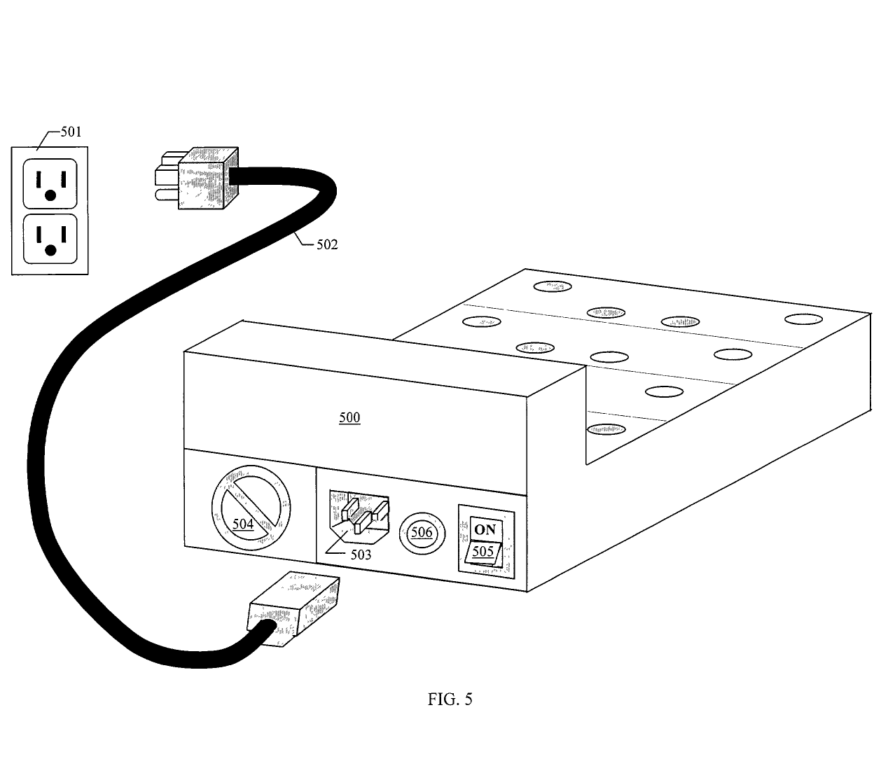

In FIG. 5, the connection between the AC/DC base unit (500) and the mains AC outlet (501) is shown in more detail. The AC/DC block derives its AC input power via one of several international cord-sets (502) through its IEC-standard male AC inlet (503). A small fan (504) may be used to provide cooling for the power supply in the base unit. An AC switch (505) allows the entire device to be powered on and off, and a user-replaceable fuse (506) is accessible via a removable unit (507).

In FIG. 6, the generation of power buses by the AC/DC base unit (600) is shown. The AC/DC base unit's AC inlet (601) carries the mains AC power into the unit, where it passes through the AC surge and transient protection circuit (602) followed by a standard EMI filter circuit (603). The filtered AC power is then applied to an AC Output Bus (604) and to the AC/DC transformation circuit (605), where it is converted to an intermediate DC voltage. This intermediate DC voltage is then directed to a DC/DC conversion circuit (606), where it is converted to a regulated 24VDC level and applied to the DC Output Bus (607). The earth ground pin of the AC inlet is applied directly to the Ground Bus (608) used by protection blocks. Note that the Ground Bus is electrically connected to the DC Output Bus “return” (-) conductor.

In FIG. 7, the distribution of power to the multitude of AC and DC sockets on the AC/DC base unit is shown in a partial cut-away view. The AC Inlet, EMI Filter, Surge and Transient Protection and AC/DC conversion/rectification circuitry (701) are housed in one end of the base unit (700). This circuitry provides both unregulated AC and DC outputs. The AC output is connected directly to the AC bus bars (702) via two conductors (703). The DC output is connected to the input of the DC/DC Converter circuit (704) via two additional conductors (705). The DC/DC Converter output is then connected via two more conductors (706) to the positive DC bus bar (707) and DC ground bus bar (708). Finally, the bus bars are connected to a series of sockets (710) placed along each bar. The placement of sockets on the respective buses in the AC/DC base unit and the corresponding placement of pins on the power and protection blocks is accomplished so as to make it impossible to plug an DC-output power block or protection block into the AC output bus. In particular, DC bus sockets (711) are placed on the AC/DC base unit farther apart than the AC bus sockets (712). Thus, the more closely spaced pins on AC power blocks can not be plugged into the DC bus sockets, nor can the pins on the DC power blocks be plugged into the more closely spaced AC bus sockets on the AC/DC base unit. The second, electrically disconnected pin on the protection blocks forces it to connect only in the same manner as a DC power block, so that it can not be plugged into the AC bus.

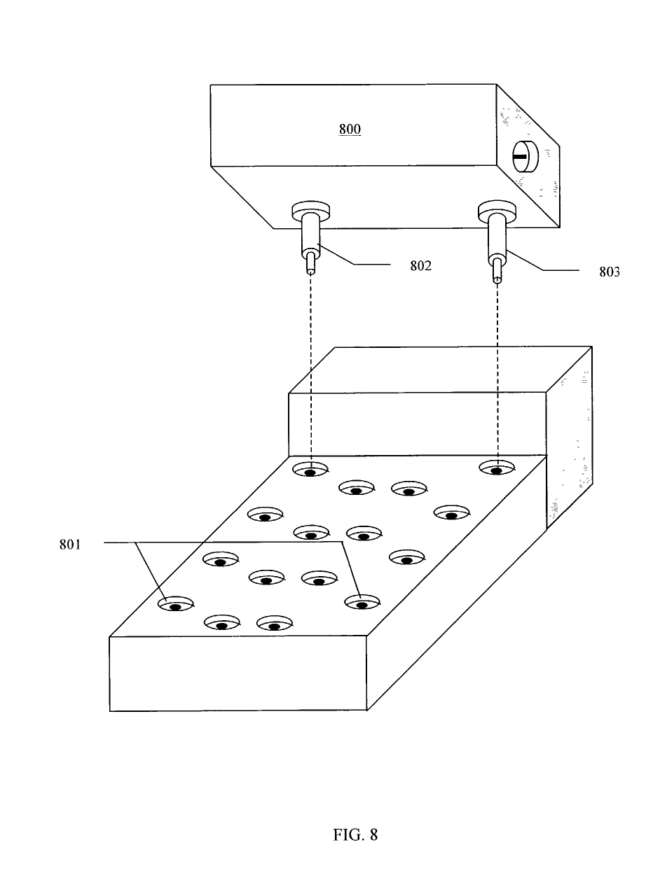

In FIG. 8, the connection between the AC/DC base-unit output buses and the modular DC power blocks is shown. The DC-output power block (800) is connected to the DC positive output bus and DC ground bus via a pair of pin sockets (801) on the bus bars and a pair of mating pin plugs (802, 803) on the power block. The pin plugs have different lengths so that the DC ground pin (802) mates prior to the DC voltage output pin (803) when the power block is plugged into the AC/DC base unit. Note that the pins on a DC power block are spaced widely to prevent them from being improperly connected to the AC bus sockets.

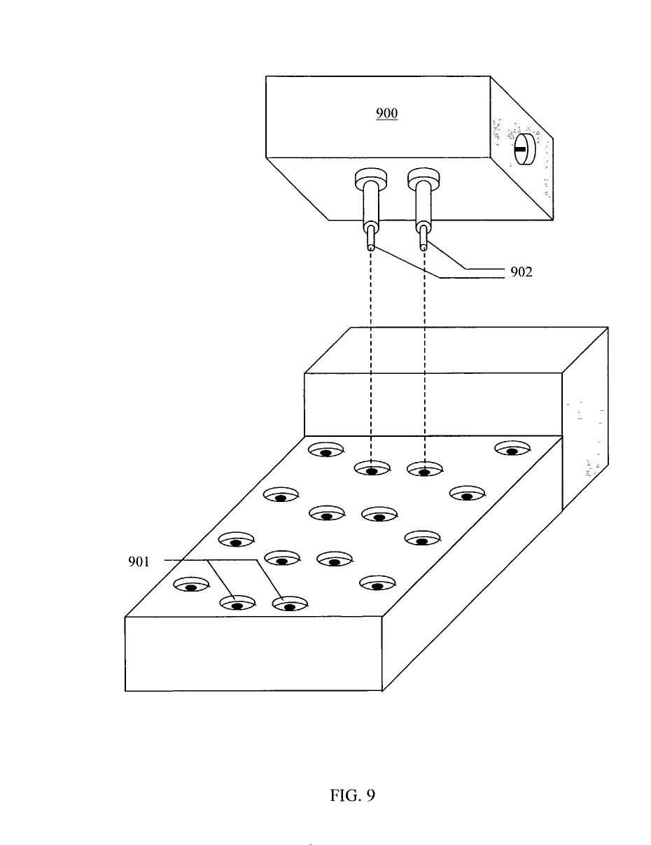

In FIG. 9, the connection between the AC/DC base-unit output buses and the modular AC power blocks is shown. The AC-output power block (900) is connected to the AC output bus via a pair of pin sockets (901) on the bus bars and a pair of mating pin plugs (902) on the power block. Note that the pins on an AC power block are spaced narrowly to prevent them from being improperly connected to the DC bus sockets.

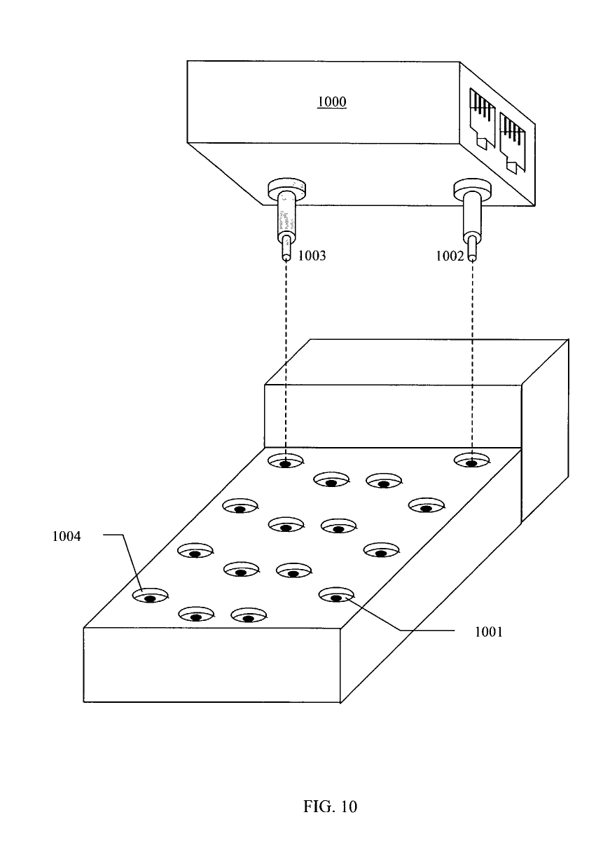

In FIG. 10, the connection between the AC/DC base-unit output buses and the modular protection blocks is shown. An exemplary protection block (1000), in this case a modem line protector, is connected to the DC ground bus via a pin socket (1001) on the ground bus bar and a mating pin plug (1002) on the protection block. A second pin plug (1003) physically mates with the DC power bus socket (1004) for mechanical connection only, since the protection block does not need DC power. No electrical connection is made to this pin, and the pin itself may even be non-conductive. Note that the pins on a protection block are spaced widely to prevent them from being improperly connected to the AC bus sockets.

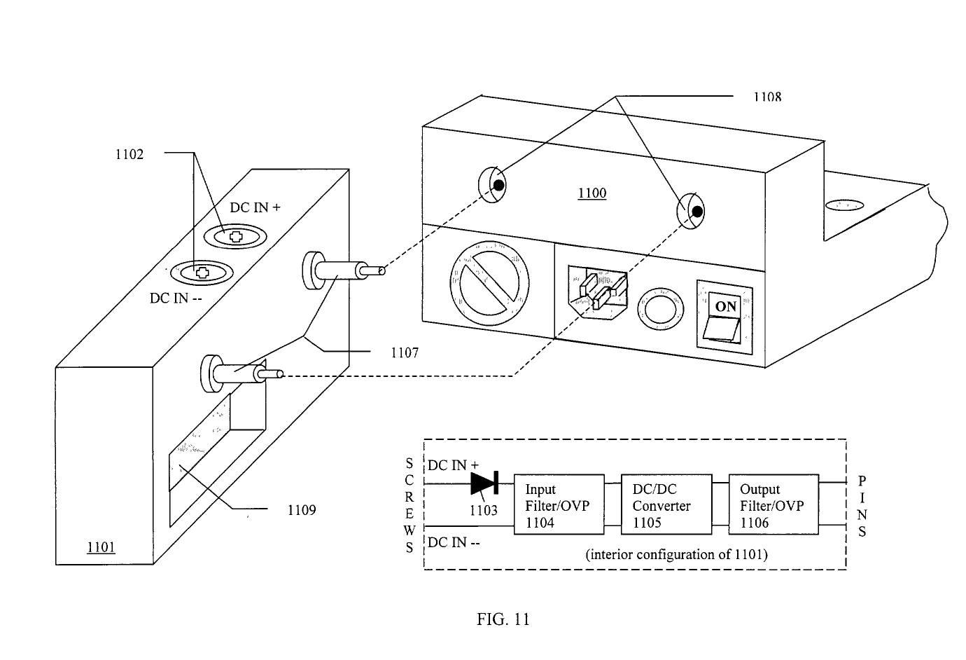

In FIG. 11, the connection of the optional DC/DC converter input module (1101) to the DC power bus within the AC/DC base unit (1100) is shown. The input module is attached to an external DC power source via the two top-mounted screw terminals (1102), and contains a reverse-polarity protection diode (1103), an input filtering and over-voltage protection circuit (1104) and a 12V-to-24V DC/DC (or optionally a 48V-to-24V DC/DC) converter (1105). An output filtering and overprotection circuit (1106) follows the output of this converter. The final output is then applied to a pair of pins (1107) that connect to mating sockets (1108) on the AC/DC base-unit. These sockets are internally connected directly to the DC bus bars. The small recess (1109) in the DC/DC input module accommodates the protruding AC fuse and power switch on the AC/DC base-unit so that the input module may be mounted flush against the end of the base-unit. In this way, the invention can be attached to a 12V DC power source such as a lead-acid battery and DC-output and “protection” blocks can be used in the usual manner without access to an AC mains power source. The 48VDC input option can be used where the available power source is a 48VDC “telecom” supply.

Although the invention has been described with reference to the particular figures herein, many alterations and changes to the invention may become apparent to those skilled in the art without departing from the spirit and scope of the present invention. Therefore, included within the patent are all such modifications as may reasonably and properly be included within the scope of this contribution to the art. As just one example, the “universal” power connector jacks and plugs may, at the output block connection (ref. FIG. 2: 202, 204; and FIG. 3: 302, 304), comprise any of a variety of common polarized connector types, the intent of the invention simply being that the same type would be used for all output blocks in order to maintain a common design and interchangeable output power cords. Of course, at the external equipment connection, the plugs may comprise any of a variety of commonly used connector types in order to mate with the jacks used by the equipment being powered (ref FIG. 2: 206-208; FIG. 3: 306-308).

What we claim as our invention is:

1. A modular power supply system comprising:
a portable AC/DC base unit having a “universal” AC input and an output comprising one each of an AC and a DC power bus;
at least one of a common DC-output power module having a programming element that sets the output voltage, a first polarized connector for making connection to the DC power bus and a second polarized connector for use with a common universal power cord;
and one of several specific terminal connectors selected to mate with the device being powered.

2. The modular power supply system recited in claim 1, and further comprising:
at least one of a common AC-output power module having a programming element that sets the output voltage, a first non-polarized connector for making connection to the AC power bus and a second non-polarized connector for use with a common universal power cord;
and one of several specific terminal connectors selected to mate with the device being powered.

3. The modular power supply system recited in claim 1, and further comprising:
at least one of a common “protection” module having surge and transient protection circuitry, a first interface-specific connector for making connection to the “input” cable of the signal being protected and a second interface-specific connector for connection to the “output” cable of the signal being protected, said pair of connectors providing a “feed-through” of the signal being protected, while allowing electrical access within the module for the inclusion of protective circuitry.

4. The modular power supply system recited in claim 1, and further comprising:
a DC/DC converter input module having a first polarized input connector for connection to a nominal 12VDC power source in an automobile or boat via a standard “cigarette lighter” type cord, and a second polarized connector for connection to the DC power bus within the AC/DC base unit.

5. The modular power supply system recited in claim 1, and further comprising:
a DC/DC converter input module having a pair of “terminal screw” inputs for connection to a nominal 48VDC “telecom” style power source and a polarized connector for connection to the DC power bus in the DC bus-only base unit described in claim 4.

6. The modular power supply system recited in claim 1, wherein said AC/DC base unit is substituted by a DC bus-only module and where the power for said module is provided by the DC/DC converter input module described in claim 4.
